(19) United States
(12) Patent Application Publication
(10) Pub. No.: US 2026/0228625 A1
(43) Pub. Date: Aug. 6, 2026

(54) INFORMATION PROCESSING APPARATUS, METHOD, AND PROGRAM

(71) Applicant: FUJIFILM Corporation, Tokyo (JP)

(72) Inventor: Ryo SHIMURA, Tokyo (JP)

(73) Assignee: FUJIFILM Corporation, Tokyo (JP)

(21) Appl. No.: 19/439,473

(22) Filed: Jan. 5, 2026

(30) Foreign Application Priority Data
Jan. 31, 2025 (JP) 2025-014968

(51) Int. Cl. G06N 20/00

(52) U.S. Cl. CPC G06N 20/00

(57) ABSTRACT

A processor is configured to divide a plurality of pieces of construction data used to construct a learning model into a plurality of data sets having a common probability distribution followed by the construction data, apply a hyperparameter selected from a plurality of hyperparameters related to the learning model to the learning model to derive an evaluation result for each of the plurality of data sets, determine a lowest evaluation result from among the evaluation results for each of the plurality of data sets as an evaluation value for the selected hyperparameter, and determine the hyperparameter by repeating the derivation of the evaluation result and the determination of the evaluation value while changing the hyperparameter until an end condition is satisfied.

### CROSS REFERENCE TO RELATED APPLICATIONS

The present application claims priority from Japanese Patent Application No. 2025-014968, filed on Jan. 31, 2025, the entire disclosure of which is incorporated herein by reference.

### BACKGROUND

### Technical Field

The present disclosure relates to an information processing apparatus, method, and program.

### Related Art

In order to construct a learning model having high accuracy by machine learning, it is necessary to appropriately set a hyperparameter of the learning model according to a target problem. The hyperparameter is a parameter that is manually set in advance in order to construct the learning model. In a case of setting the hyperparameter, an optimization method such as random search, grid search, or Bayesian optimization is used. The hyperparameter is set by using such an optimization method in the following procedure.
1) Select one combination of hyperparameters, and construct the learning model by learning the training data using the selected combination of hyperparameters.
2) Evaluate the performance of the learning model using the validation data.
3) Repeatedly perform 1) and 2), and specify a combination of hyperparameters that achieves the highest evaluation result.

Random search is a method of randomly selecting the combination of hyperparameters in 1), and grid search is a method of selecting the combination of hyperparameters at equal intervals in 1). Bayesian optimization is a method of selecting the next combination of hyperparameters in consideration of a result obtained by a combination of hyperparameters that have been tried so far.

Various methods for determining such a hyperparameter have been proposed (for example, see JP2022-150947A). The method described in JP2022-150947A is a method of setting a number of times of learning in advance, performing the learning a predetermined number of times by using the learning model constructed by applying a predetermined value to the hyperparameter included in a solution space of the hyperparameter, repeatedly calculating an evaluation value of the learning model while changing the predetermined value of the hyperparameter, and determining an optimal hyperparameter based on the calculated evaluation value.

On the other hand, for example, a holdout method and a cross-validation method are used to evaluate the performance of the learning model. The holdout method is a method of dividing data used to construct the learning model (hereinafter, referred to as construction data) into training data and validation data, and evaluating the learning model constructed by using the training data by using the validation data.

In the cross-validation method, the construction data is divided into K (K≥2) data sets, and in each data set, one validation data is selected and the rest is used as training data. Then, the learning using the training data and the evaluation using the validation data are performed for each data set, and an average value of K evaluation results obtained is evaluated as the performance of the learning model.

On the other hand, even after an operation of the constructed learning model is started, an accuracy of the learning model can be maintained by performing continuous learning of continuously collecting data and performing learning to periodically update the model. Such continuous learning is performed in a system in which user behavior is affected by a season or a trend, or in a case in which the learning model is operated in a facility (store) or a region different from the facility that acquires the construction data.

In general, the learning model is constructed by assuming that the distribution of data matches between the training data and the validation data. In this case, a hyperparameter that is optimized for the training data is also used. On the other hand, a phenomenon (distribution shift phenomenon) in which data applied to the learning model during operation has a distribution different from the training data is known. The distribution shift phenomenon occurs, for example, due to a difference in region, a difference in base (store and facility), or a difference in data acquisition period between the training data used to construct the learning model and the data used in operation.

By performing the above-described continuous learning, the possibility of obtaining data having the same distribution as the validation data during operation is high, so that the distribution shift phenomenon can be alleviated. In this case, it is preferable to re-optimize the hyperparameter in order to maintain the performance of the learning model. However, since the optimization of the hyperparameter requires a large amount of computational cost, it is not realistic to perform the optimization of the hyperparameter in the continuous learning. Therefore, depending on the data used for actual operation, the learning model may unexpectedly deteriorate in performance.

### SUMMARY OF THE INVENTION

The present disclosure has been made in view of the above circumstances, and an object thereof is to determine a hyperparameter such that deterioration in performance of a learning model due to a distribution shift phenomenon can be prevented.

An information processing apparatus according to the present disclosure includes a processor, in which the processor is configured to divide a plurality of pieces of construction data used to construct a learning model into a plurality of data sets having a common probability distribution followed by the construction data, apply a hyperparameter selected from a plurality of hyperparameters related to the learning model to the learning model to derive an evaluation result for each of the plurality of data sets, determine a lowest evaluation result from among the evaluation results for each of the plurality of data sets as an evaluation value for the selected hyperparameter, and determine the hyperparameter by repeating the derivation of the evaluation result and the determination of the evaluation value while changing the hyperparameter until an end condition is satisfied.

In the information processing apparatus according to the present disclosure, the processor may be configured to determine a hyperparameter to be selected next based on the evaluation value.

In the information processing apparatus according to the present disclosure, the plurality of pieces of construction data may be acquired in a plurality of domains, and the processor may be configured to divide the plurality of pieces of construction data into the plurality of data sets for each of the domains.

In the information processing apparatus according to the present disclosure, the end condition may include at least one of the number of times of selection of the hyperparameter, a processing time for determining the hyperparameter, or an achievement criterion of the evaluation value.

An information processing method according to the present disclosure, executed by a computer, the method includes: dividing a plurality of pieces of construction data used to construct a learning model into a plurality of data sets having a common probability distribution followed by the construction data; applying a hyperparameter selected from a plurality of hyperparameters related to the learning model to the learning model to derive an evaluation result for each of the plurality of data sets; determining a lowest evaluation result from among the evaluation results for each of the plurality of data sets as an evaluation value for the selected hyperparameter; and determining the hyperparameter by repeating the derivation of the evaluation result and the determination of the evaluation value while changing the hyperparameter until an end condition is satisfied.

An information processing program according to the present disclosure causing a computer to execute: a procedure of dividing a plurality of pieces of construction data used to construct a learning model into a plurality of data sets having a common probability distribution followed by the construction data; a procedure of applying a hyperparameter selected from a plurality of hyperparameters related to the learning model to the learning model to derive an evaluation result for each of the plurality of data sets; a procedure of determining a lowest evaluation result from among the evaluation results for each of the plurality of data sets as an evaluation value for the selected hyperparameter; and a procedure of determining the hyperparameter by repeating the derivation of the evaluation result and the determination of the evaluation value while changing the hyperparameter until an end condition is satisfied.

It should be noted that the technology of the present disclosure may be applied to a program product.

According to the present disclosure, it is possible to determine the hyperparameter such that the deterioration in performance of the learning model due to the distribution shift phenomenon can be prevented.

### BRIEF DESCRIPTION OF THE DRAWINGS

FIG. 1 is a diagram showing a schematic configuration of a medical information system to which an information processing apparatus according to an embodiment of the present disclosure is applied.

FIG. 2 is a diagram showing a hardware configuration of the information processing apparatus according to the present embodiment.

FIG. 3 is a functional configuration diagram of the information processing apparatus according to the present embodiment.

FIG. 4 is a diagram showing a probability distribution of construction data.

FIG. 5 is a diagram showing a probability distribution of a data set.

FIG. 6 is a diagram schematically showing processing performed by an evaluation result derivation unit and an evaluation value determination unit.

FIG. 7 is a diagram for describing division of training data and validation data in a holdout method.

FIG. 8 is a diagram for describing division of training data and validation data in a cross-validation method.

FIG. 9 is a diagram for describing derivation of an evaluation result in the cross-validation method.

FIG. 10 is a diagram schematically showing optimization of a hyperparameter in the related art.

FIG. 11 is a diagram schematically showing optimization of a hyperparameter in the present embodiment.

FIG. 12 is a flowchart showing processing performed in the present embodiment.

### DESCRIPTION OF THE PREFERRED EMBODIMENTS

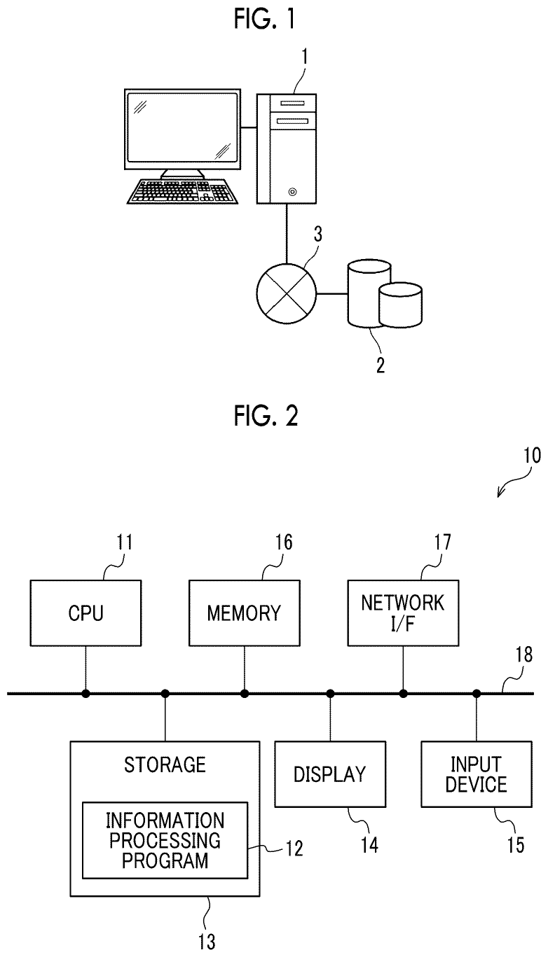

Hereinafter, embodiments of the present disclosure will be described with reference to the drawings. First, a configuration of a learning system to which an information processing apparatus according to the present embodiment is applied will be described. FIG. 1 is a diagram showing a schematic configuration of the learning system. In the learning system shown in FIG. 1, a computer 1 including the information processing apparatus according to the present embodiment and a data server 2 are connected via a network 3 in a communicable state.

The computer 1 includes the information processing apparatus according to the present embodiment, and an information processing program according to the present embodiment is installed in the computer 1. The computer 1 may be a workstation or a personal computer or may be a server computer connected to the workstation or the personal computer through a network. The information processing program is stored in a storage device of the server computer connected to the network or in a network storage to be accessible from the outside, and is, in response to a request, downloaded and installed in the computer 1 used by the doctor. Alternatively, the information processing program is distributed in a state of being recorded on a recording medium, such as a digital versatile disc (DVD) or a compact disc read-only memory (CD-ROM), and is installed in the computer 1 from the recording medium.

The data server 2 is a computer that stores and manages a plurality of pieces of construction data used to construct a learning model described below, and comprises a large-capacity external storage device and software for database management. The data server 2 communicates with other devices via the wired or wireless network 3 to transmit and receive data and the like.

It should be noted that the data server 2 stores the construction data based on the purpose of the learning model to be constructed. For example, management data acquired in each store of a supermarket for use in constructing a learning model used in a management system of a product in the supermarket is stored as the construction data. In addition, medical data acquired in a plurality of hospitals for constructing a learning model used in a hospital internal system for diagnosis in a hospital is stored as the construction data.

Next, the information processing apparatus according to the present embodiment will be described. FIG. 2 is a diagram showing a hardware configuration of the information processing apparatus according to the present embodiment. As shown in FIG. 2, an information processing apparatus 10 includes a central processing unit (CPU) 11, a non-volatile storage 13, and a memory 16 as a temporary storage area. In addition, the information processing apparatus 10 includes a display 14, such as a liquid crystal display, an input device 15, such as a keyboard and a mouse, and a network interface (I/F) 17 connected to the network 3. The CPU 11, the storage 13, the display 14, the input device 15, the memory 16, and the network I/F 17 are connected to a bus 18. It should be noted that the CPU 11 is an example of a processor according to the present disclosure.

The storage 13 is achieved by a hard disk drive (HDD), a solid state drive (SSD), a flash memory, or the like. An information processing program 12 is stored in the storage 13 as the storage medium. The CPU 11 reads the information processing program 12 from the storage 13, loads the information processing program 12 into the memory 16, and executes the loaded information processing program 12.

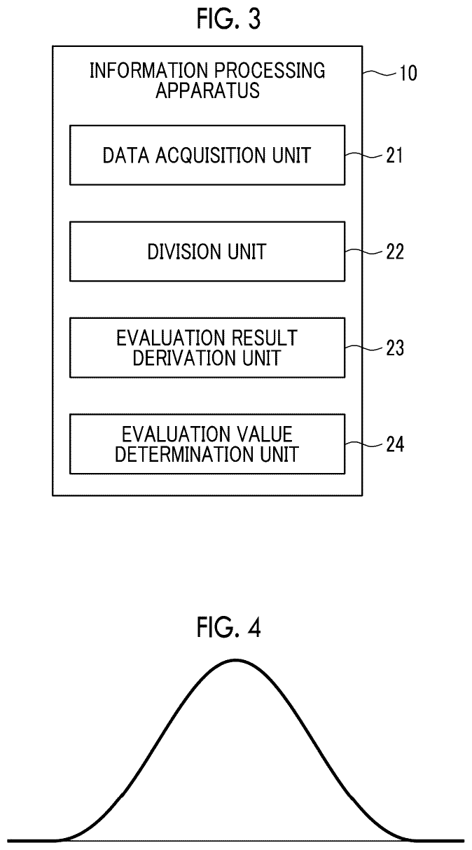

Next, a functional configuration of the information processing apparatus according to the present embodiment will be described. FIG. 3 is a diagram showing a functional configuration of the information processing apparatus according to the present embodiment. As shown in FIG. 3, the information processing apparatus 10 comprises a data acquisition unit 21, a division unit 22, an evaluation result derivation unit 23, and an evaluation value determination unit 24. Then, in a case in which the CPU 11 executes the information processing program 12, the CPU 11 functions as the data acquisition unit 21, the division unit 22, the evaluation result derivation unit 23, and the evaluation value determination unit 24.

The data acquisition unit 21 acquires a plurality of pieces of construction data used to construct the learning model from the data server 2 in response to an instruction from the input device 15 by an operator. For example, in a case of constructing the learning model used in the management system of the product in the supermarket, the construction data is management data of the product acquired in the plurality of stores of the supermarket. In addition, in a case of constructing the learning model used in the hospital internal system for diagnosis in the hospital, the construction data is medical data acquired in the plurality of hospitals.

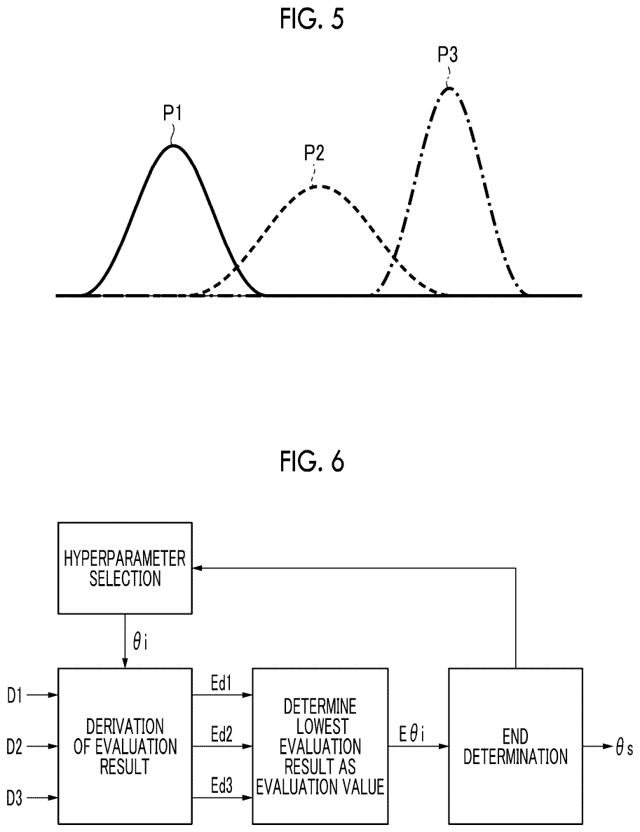

The division unit 22 divides the plurality of pieces of construction data acquired by the data acquisition unit 21 into a plurality of data sets having a common probability distribution followed by the data. The probability distribution of the plurality of pieces of construction data is often a normal distribution as shown in FIG. 4. On the other hand, in a case in which domains such as a facility (store and hospital) from which the data is acquired, a region from which the data is acquired, a period in which the data is acquired, and a target (gender and age) from which the data is acquired are different in the plurality of pieces of construction data, the probability distribution of the data for each data set is divided into, for example, three distributions P1 to P3 having different peaks and spreads as shown in FIG. 5. The distributions P1 to P3 of the data obtained by dividing the data into three have a common probability distribution of the construction data included in each of the distributions P1 to P3. The division unit 22 divides the plurality of pieces of construction data into a plurality of data sets having a common probability distribution in this way. For example, the division unit 22 divides the plurality of pieces of construction data into a plurality of data sets by assigning a common label to the data sets having a common probability distribution.

The number of data sets divided by the division unit 22 may be given in advance, or may be set according to the type of the domain by a rule-based method or the like. For example, in a case in which the plurality of pieces of acquired construction data are acquired in three facilities, the plurality of pieces of construction data may be divided into three data sets for each facility.

On the other hand, in a case in which the construction data is acquired from a plurality of facilities, in some cases, depending on the facility, data from other facilities is prohibited from being analyzed together with the data from the facility. For example, in some cases, data acquired in the hospital is prohibited from being used together with data acquired in other hospitals for analysis. In such a case, the division unit 22 may divide the plurality of pieces of construction data into data sets for each facility.

Hereinafter, processing performed by the evaluation result derivation unit 23 and the evaluation value determination unit 24 will be described. FIG. 6 is a diagram schematically showing processing performed by the evaluation result derivation unit 23 and the evaluation value determination unit 24. In the following description, the number of data sets divided by the division unit 22 is three, and the data sets are referred to as data sets D1 to D3.

The evaluation result derivation unit 23 applies one hyperparameter selected from the plurality of hyperparameters to the learning model to derive an evaluation result for each of the plurality of data sets. The hyperparameter is a parameter that is manually set in advance in order to construct the learning model, and specifically, in a case in which the learning model is a neural network, the number of layers of the neural network for constructing the learning model, the number of units in the layer, the number of clusters, the patch size, and the like are exemplified. On the other hand, in a case in which the learning model is a decision tree, the depth of the tree, the minimum number of data of the leaf, the minimum number of data for division, and the like are exemplified.

For example, in a case in which the learning model is a decision tree, in a case in which the set value of the depth of the tree is 3, the set value of the minimum number of data of the leaf is 3, and the set value of the minimum number of data for division is 3, the number of combinations of the hyperparameters is 3³=27. Hereinafter, θi (i=1 to M, Mis the number of combinations of the hyperparameters) will be used as a reference numeral of the hyperparameter.

The evaluation result derivation unit 23 selects the hyperparameter by sequentially searching for the hyperparameter from the combination of the plurality of hyperparameters by using a method of grid search, random search, or Bayesian optimization, and derives the evaluation result.

On the other hand, the evaluation result derivation unit 23 divides the plurality of pieces of construction sub-data included in each of the plurality of data sets D1 to D3 divided by the division unit 22 into training data and validation data. As a method of dividing the data, a holdout method and a cross-validation method can be used.

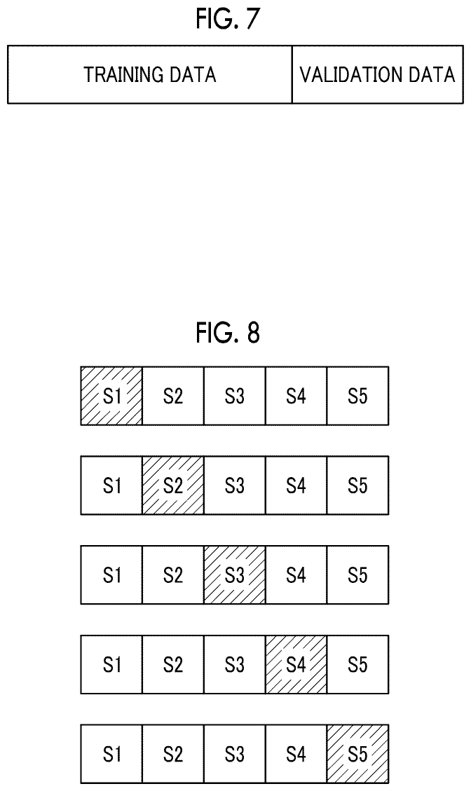

In a case in which the holdout method is used, as shown in FIG. 7, the plurality of pieces of sub-data are divided into the training data and the validation data in a predetermined ratio (for example, 7:3, 6:4, and the like). In a case in which the holdout method is used, in each of the data sets D1 to D3, the learning model is constructed by using the training data for the selected hyperparameter, and the evaluation results Ed1 to Ed3 of the learning model are derived by using the validation data.

In a case in which the cross-validation method is used, the evaluation result derivation unit 23 divides the plurality of pieces of sub-data into K parts, selects one validation data in each of the plurality of data sets (hereinafter, referred to as divided data sets) divided into K parts, and uses the rest as the training data. For example, in a case in which the plurality of pieces of sub-data are divided into five data groups S1 to S5, as shown in FIG. 8, in a case in which the data group S1 is used as the validation data and the data groups S2 to S5 are used as the training data, in a case in which the data group S2 is used as the validation data and the data groups S1, S3 to S5 are used as the training data, in a case in which the data group S3 is used as the validation data and the data groups S1, S2, S4, and S5 are used as the training data, in a case in which the data group S4 is used as the validation data and the data groups S1 to S3 and S5 are used as the training data, and in a case in which the data group S5 is used as the validation data and the data groups S1 to S4 are used as the training data, evaluation results for five divided data sets are derived. In FIG. 8, hatching is applied to the validation data.

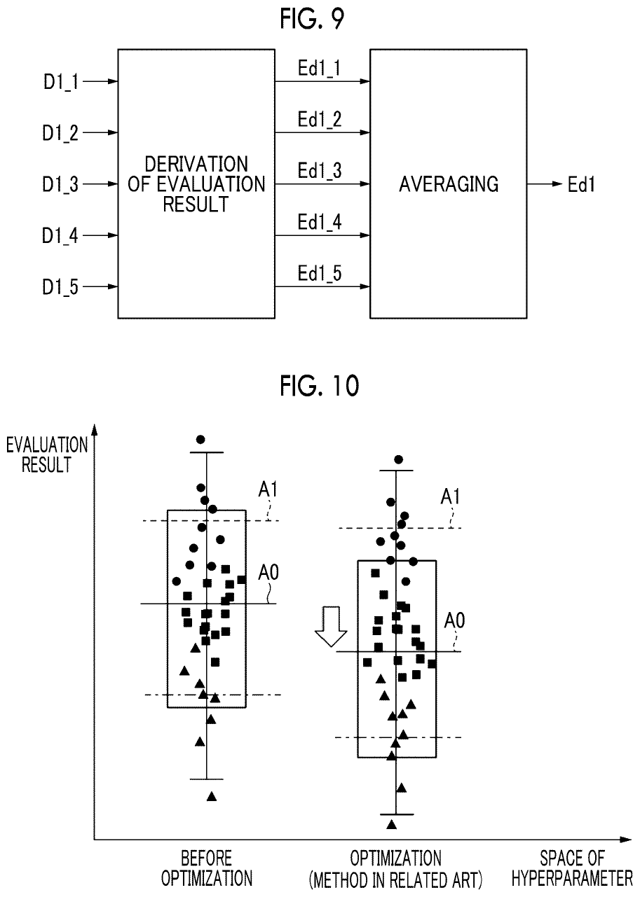

In the cross-validation method, for example, it is assumed that the data set D1 is divided into five parts to obtain divided data sets D1_1 to D1_5. In this case, as shown in FIG. 9, the learning model is constructed by using the training data, and the evaluation results Ed1_1 to Ed1_5 are derived by using the validation data for each of the divided data sets D1_1 to D1_5. The evaluation result derivation unit 23 derives an average value of the five evaluation results Ed1_1 to Ed1_5 as the evaluation result Ed1 of the data set D1.

The evaluation result derivation unit 23 derives the evaluation results Ed1 to Ed3 for each of the plurality of data sets D1 to D3 for the currently selected hyperparameter.

In a case in which the learning model outputs a prediction value for an input, the evaluation result is a difference between an output value of the learning model and a correct answer of the validation data. In this case, the evaluation result is an absolute value of a difference between the output value of the learning model and the correct answer included in the validation data, or a squared difference of the difference, and the smaller the evaluation result, the higher the performance of the learning model. On the other hand, in a case in which the learning model outputs model performance such as sensitivity, specificity, area under the curve (AUC)-receiver operating characteristic (ROC), and goodness-of-fit, the output value of the learning model itself is the evaluation result, and the larger the value of the evaluation result, the higher the performance of the learning model.

The evaluation value determination unit 24 derives the lowest evaluation result among the evaluation results Ed1 to Ed3 derived for each of the plurality of data sets D1 to D3 for the selected hyperparameter as an evaluation value Efi for the selected hyperparameter θi. In a case in which the learning model outputs a prediction value for an input, the lowest evaluation result is an evaluation result having the maximum value. On the other hand, in a case in which the learning model outputs model performance, the lowest evaluation result is an evaluation result having the minimum value.

The evaluation value determination unit 24 determines whether or not an end condition for constructing the learning model is satisfied. In a case in which the end condition is not satisfied, the evaluation result derivation unit 23 selects the next hyperparameter, and the evaluation value determination unit 24 determines the hyperparameter θs by repeating the derivation of the evaluation result and the determination of the evaluation value while changing the hyperparameter until the end condition is satisfied.

The end condition is at least one of selecting the hyperparameter for a predetermined number of times of search, performing learning for a predetermined time, or satisfying an achievement condition of the evaluation value Efi.

It is preferable that the number of times of search is set to be approximately half of all the combinations of the hyperparameters from the viewpoint of improving the efficiency of processing. For example, in a case in which there are three types of the hyperparameters and there are five set values for each of the types of the hyperparameters, the number of combinations of the hyperparameters is 5³=125. In this case, the number of times of search can be set to be approximately 50 to 70.

The learning time can be determined according to the time required to determine the evaluation value using one hyperparameter, the number of times of search, and the usage fee of the server used for learning. For example, in a case in which the time required to perform learning for one hyperparameter is 10 minutes, the number of times of search is approximately 50, and the usage fee is desired to be within 100,000 yen in a server with a usage amount of 10,000 yen per hour, the learning time can be set to be approximately 8 to 10 hours.

As the achievement condition, in a case in which the learning model outputs the prediction value for the input, the evaluation value can be set to be less than a predetermined threshold value. On the other hand, in a case in which the learning model outputs model performance, the achievement condition can be set to be that the evaluation value exceeds a predetermined threshold value. In the latter case, the achievement condition can be set to be sensitivity of 80% or more and specificity of 95% or more, ROC-AUC of 0.9 or more, or any combination thereof.

The determined hyperparameter θs is the hyperparameter θi in a case in which the best evaluation value Efi among the evaluation values Eθi derived until the end condition is satisfied is derived. The determined hyperparameter θs is set as the optimal hyperparameter. In a case in which the learning model outputs the prediction value for the input, the best evaluation value is the evaluation value having the smallest value. In a case in which the learning model outputs model performance, the best evaluation value is the evaluation value having the largest value.

In a case in which the next hyperparameter is selected, the evaluation result derivation unit 23 selects the next hyperparameter in the following order in a case in which the grid search is used. In a case in which the random search is used, the evaluation result derivation unit 23 randomly selects the next hyperparameter. In a case in which the method of Bayesian optimization is used, the evaluation result derivation unit 23 selects the hyperparameter by searching for the hyperparameter that can obtain a learning model having close performance based on the evaluation value derived so far.

The processing of the hyperparameter optimization in the present embodiment is represented by Equation (1) using an equation.

$${θ}_{s} = {arg min}_{θ ∈ Θ} {max}_{q ∈ Q} {f}_{val} ( {D}_{val}^{( q )} , θ ) \qquad ( 1 )$$

θ is a hyperparameter, Θ is a set of hyperparameters,

$${D}_{val}^{( q )}$$

is a dataset of a plurality of pieces of data whose domain is q, Q is a set of datasets, the set of all domains, and fval(D, θ) is the evaluation result derived from the input dataset D and the selected hyperparameter θ.

Equation (1) represents an equation in a case in which the learning model outputs a prediction value for an input. As shown in Equation (1), in the processing in the present embodiment, the optimal hyperparameter θs is determined such that the lowest evaluation result (that is, the maximum difference) for each of the plurality of data sets is minimized. For example, in the present embodiment, in a case in which q=data sets D1 to D3, in Equation (1),

$${max}_{q ∈ Q} {f}_{val} ( {D}_{val}^{( q )} , θ ) = max ( {f}_{val}^{f = D 1} , {f}_{val}^{q = D 2} , {f}_{val}^{q = D 3} )$$

is obtained.

In a case in which the learning model outputs model performance, optimization similar to that of Equation (1) can be represented by multiplying

$${max}_{q ∈ Q} {f}_{val} ( {D}_{val}^{( q )} , θ )$$

### in Equation (1) by −1.

Alternatively, the optimal hyperparameter θs is determined such that the lowest evaluation result (that is, the minimum evaluation result) is maximized by reversing min and max in Equation (1).

Next, a difference between a method of determining the hyperparameter in the related art and a method of determining the hyperparameter in the present embodiment will be described. The method in the related art is a method of using a plurality of pieces of construction data used to construct the learning model without dividing the plurality of pieces of construction data into data sets, and determining the hyperparameter such that the derived evaluation result is minimized.

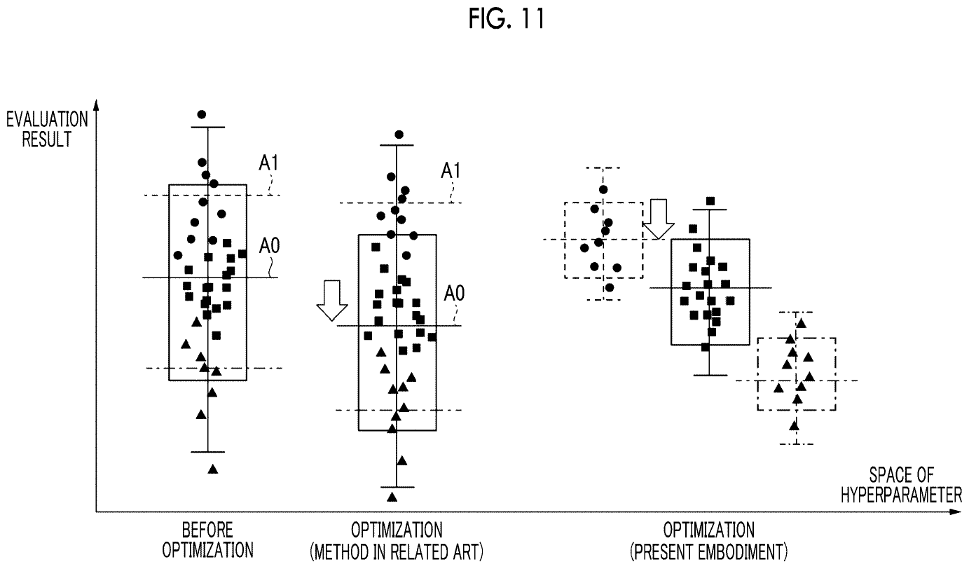

FIG. 10 is a diagram schematically showing optimization of the hyperparameter in the related art. In FIG. 10, black circles, black squares, and black triangles are evaluation results obtained in divided data divided into K parts for cross-validation for each of the data sets D1 to D3, for example, in a case in which the plurality of pieces of construction data are divided into three data sets D1 to D3. In FIG. 10 and FIG. 11 described below, the number of data of the data set D2 is larger than the number of data of the data sets D1 and D3.

In the method in the related art, the evaluation result is derived for each divided data acquired by dividing the plurality of pieces of construction data into K parts, and the optimal hyperparameter is determined such that an average value of the evaluation results for all the divided data is minimized. That is, in FIG. 10, the optimal hyperparameter is determined such that an average value A0 of the entire construction data is minimized.

However, in a case in which the hyperparameter is determined in this way, an average value A1 (indicated by a broken line) of the evaluation results derived for the data set on the side with the poor evaluation result is not significantly reduced even by the optimization. In a case in which the learning model using the optimized hyperparameter is actually operated, in a case in which the actual data input to the learning model is close to the average value of the construction data used to construct the learning model, a preferable output is made from the learning model. Probabilistically, this situation is most likely to occur.

However, in a case in which the actual data input to the learning model is within a range including the plurality of data sets D1, it is unlikely but there is a possibility that a preferable result is not output from the learning model. In this case, the performance of the constructed learning model unexpectedly deteriorates. In this case, in an environment in which the learning model is used, the deterioration in performance can be alleviated to some extent by performing continuous learning of the parameter of the learning model (that is, the weight between the layers and the like) instead of the hyperparameter. However, it is difficult to determine the optimal hyperparameter again because the computational cost is high.

FIG. 11 is a diagram schematically showing optimization of the hyperparameter in the present embodiment. In FIG. 11, as in FIG. 10, black circles, black squares, and black triangles are evaluation results obtained in divided data divided into K parts for cross-validation for each of the data sets D1 to D3 in a case in which the plurality of pieces of construction data are divided into three data sets D1 to D3. In addition, the average values A1 to A3 are average values of the evaluation values of the divided data divided into K parts for each of the data sets D1 to D3.

As shown in FIG. 11, in the present embodiment, the hyperparameter is optimized such that the average value A1 in the data set D1 having the lowest evaluation result is reduced.

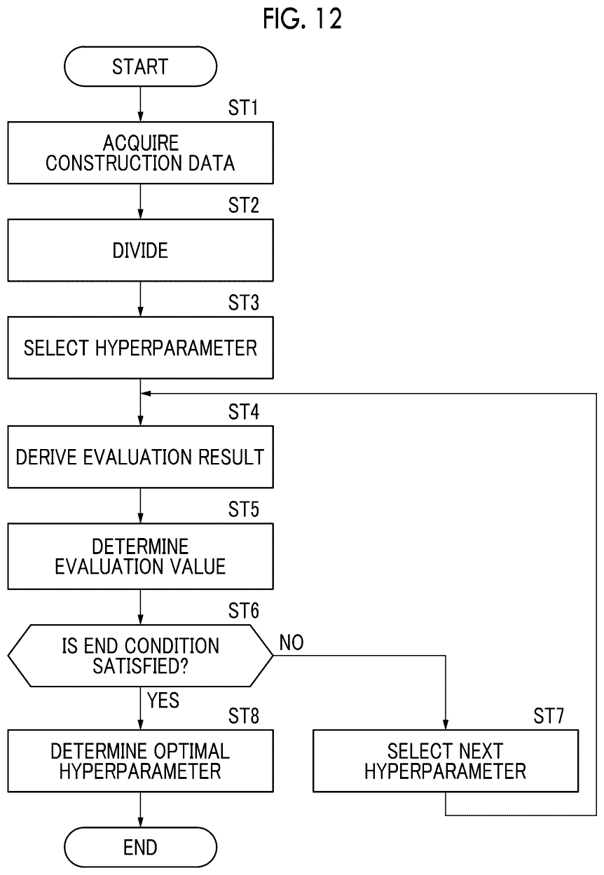

Next, processing performed in the present embodiment will be described. FIG. 12 is a flowchart showing processing performed in the present embodiment. First, the data acquisition unit 21 acquires a plurality of pieces of construction data for constructing the learning model (step ST1). The division unit 22 divides the plurality of pieces of construction data into three or more data sets having a common probability distribution followed by the data (step ST2). In the present embodiment, the plurality of pieces of construction data are divided into the three data sets D1 to D3.

The evaluation result derivation unit 23 selects the first hyperparameter from the combination of the plurality of hyperparameters (step ST3), and derives the evaluation result for each of the data sets D1 to D3 by using the selected hyperparameter (step ST4). The evaluation value determination unit 24 determines the lowest evaluation result from among the evaluation results derived for each of the data sets D1 to D3 as the evaluation value for the hyperparameter that is being selected (step ST5). The evaluation value determination unit 24 determines whether or not the end condition is satisfied (step ST6), and in a case in which the determination result in step ST6 is No, the evaluation result derivation unit 23 selects the next hyperparameter (step ST7), and the processing returns to step ST4 to repeat the processing of steps ST4 to ST6.

In a case in which the determination result in step ST6 is Yes, the hyperparameter having the best evaluation value among the evaluation values so far is determined as the optimal hyperparameter (step ST8), and the processing is ended.

The learning model constructed by the hyperparameter determined in this way is provided to a facility such as a hospital or a store and operated. In each facility, the distribution of the data applied to the learning model may shift from the distribution of the construction data used to construct the learning model due to a difference in system operation for each base, a change in an in-store or out-of-store environment (for example, a new system is introduced, the surrounding traffic situation changes, and the like) with the passage of time, and a change in behavior of the staff (employees of the store, medical workers, and the like) of the facility with the passage of time.

During the operation of the learning model, the data in the facility is collected at regular intervals, and the learning model is continuously trained by the collected data. However, since the optimization of the hyperparameter requires a large amount of computational cost, it is not realistic to perform the optimization in the continuous learning. Therefore, depending on the data used for actual operation, the learning model may unexpectedly deteriorate in performance.

In the present embodiment, the plurality of pieces of construction data used to construct the learning model are divided into three or more data sets D1 to D3 having a common probability distribution followed by the data, the hyperparameter selected from the plurality of hyperparameters is applied to the learning model to derive the evaluation results Ed1 to Ed3 for each of the plurality of data sets D1 to D3, the lowest evaluation result from among the evaluation results for each of the plurality of data sets D1 to D3 is determined as the evaluation value for the selected hyperparameter, and the optimal hyperparameter is determined by repeating the derivation of the evaluation result and the determination of the evaluation value while changing the hyperparameter until the end condition is satisfied.

Therefore, even in a case in which the distribution of the data input to the learning model during operation is shifted from the distribution of the data used for learning, the optimal hyperparameter can be determined to cope with the shift, as compared with a case in which the learning model is constructed without dividing the data used for learning. Therefore, it is possible to prevent the unexpected deterioration in performance of the learning model during operation.

In the present embodiment, each processing is executed by any computer. In addition, any computer may execute these processes by a processor as hardware, a program as software, or a combination thereof. In such a case, the processor is configured to execute various types of processing according to the present embodiment in cooperation with the program, and can function as each unit or each means in the present embodiment. In addition, the execution order of the processing by the processor is not limited to the order described above and may be changed as appropriate. Any computer may be a general-purpose computer, a computer for a specific use, a workstation, or another system capable of executing each process.

The processor may be configured by one or a plurality of hardware, and the type of hardware is not limited. For example, the processor may be configured by hardware such as a central processing unit (CPU), a micro processing unit (MPU), a programmable logic device such as a field programmable gate array (FPGA), a dedicated circuit for executing specific processing such as an application specific integrated circuit (ASIC), a graphic processing unit (GPU), or a neural processing unit (NPU). In addition, the types of hardware may be a combination of different types of hardware. In a case where a plurality of hardware are configured to execute one or a plurality of processes of a certain processor, the plurality of hardware may be present in devices physically separated from each other, or may be present in the same device. In addition, in any of the embodiments, the order of each processing by the processor is not limited to the above order, and may be changed as appropriate. The hardware is configured using an electrical circuit (circuitry) in which circuit elements, such as semiconductor elements, are combined, or the like.

Furthermore, the program may be software such as firmware or a microcode. In addition, the program may be, for example, a program module group, and each function thereof may be realized by a processor configured to execute each function. The program may be a program code or a plurality of code segments stored in one or more non-transitory computer-readable media (for example, storage media, other storages, or the like). The program may be stored in a plurality of non-transitory computer-readable media existing in devices physically separated from each other. The program code or code segment may represent any combination of a procedure, a function, a subprogram, a routine, a subroutine, a module, a software package, a class, or an instruction, a data structure, or a program statement. The program code or code segment may be connected to another code segment or a hardware circuit by transmitting and receiving information, data, an argument, a parameter, or a content of a memory.

Further, in the above-described embodiment, an aspect has been described in which the information processing program 12 is stored (installed) in advance in the storage 13, but the present disclosure is not limited to this aspect. The information processing program 12 may be provided in a form recorded on a recording medium, such as a compact disc read-only memory (CD-ROM), a digital versatile disc read-only memory (DVD-ROM), and a universal serial bus (USB) memory. Furthermore, the information processing program 12 may be provided in a form that can be downloaded from an external device via a network.

The technology of the present disclosure extends to all kinds of program products. The program product includes products in all aspects for providing a program. For example, the program product includes a program provided through a network such as the Internet, a non-transitory computer-readable recording medium, such as a CD-ROM, a DVD, and a USB memory in which the program is stored, and the like.

The supplementary notes of the present disclosure will be described as follows.

### Supplementary Note 1

An information processing apparatus including:
a processor,
in which the processor is configured to:
divide a plurality of pieces of construction data used to construct a learning model into a plurality of data sets having a common probability distribution followed by the construction data;
apply a hyperparameter selected from a plurality of hyperparameters related to the learning model to the learning model to derive an evaluation result for each of the plurality of data sets;
determine a lowest evaluation result from among the evaluation results for each of the plurality of data sets as an evaluation value for the selected hyperparameter; and
determine the hyperparameter by repeating the derivation of the evaluation result and the determination of the evaluation value while changing the hyperparameter until an end condition is satisfied.

### Supplementary Note 2

The information processing apparatus according to Supplementary Note 1,
in which the processor is configured to determine a hyperparameter to be selected next based on the evaluation value.

### Supplementary Note 3

The information processing apparatus according to Supplementary Note 1 or 2,
in which the plurality of pieces of construction data are acquired in a plurality of domains, and
the processor is configured to divide the plurality of pieces of construction data into the plurality of data sets for each of the domains.

### Supplementary Note 4

The information processing apparatus according to any one of Supplementary Notes 1 to 3,
in which the end condition includes at least one of the number of times of selection of the hyperparameter, a processing time for determining the hyperparameter, or an achievement criterion of the evaluation value.

### Supplementary Note 5

An information processing method executed by a computer, the method including:
dividing a plurality of pieces of construction data used to construct a learning model into a plurality of data sets having a common probability distribution followed by the construction data;
applying a hyperparameter selected from a plurality of hyperparameters related to the learning model to the learning model to derive an evaluation result for each of the plurality of data sets;
determining a lowest evaluation result from among the evaluation results for each of the plurality of data sets as an evaluation value for the selected hyperparameter; and
determining the hyperparameter by repeating the derivation of the evaluation result and the determination of the evaluation value while changing the hyperparameter until an end condition is satisfied.

### Supplementary Note 6

An information processing program causing a computer to execute:
a procedure of dividing a plurality of pieces of construction data used to construct a learning model into a plurality of data sets having a common probability distribution followed by the construction data;
a procedure of applying a hyperparameter selected from a plurality of hyperparameters related to the learning model to the learning model to derive an evaluation result for each of the plurality of data sets;
a procedure of determining a lowest evaluation result from among the evaluation results for each of the plurality of data sets as an evaluation value for the selected hyperparameter; and
a procedure of determining the hyperparameter by repeating the derivation of the evaluation result and the determination of the evaluation value while changing the hyperparameter until an end condition is satisfied.

What is claimed is:

1. An information processing apparatus comprising:
a processor,
wherein the processor is configured to:
divide a plurality of pieces of construction data used to construct a learning model into a plurality of data sets having a common probability distribution followed by the construction data;
apply a hyperparameter selected from a plurality of hyperparameters related to the learning model to the learning model to derive an evaluation result for each of the plurality of data sets;
determine a lowest evaluation result from among the evaluation results for each of the plurality of data sets as an evaluation value for the selected hyperparameter; and
determine the hyperparameter by repeating the derivation of the evaluation result and the determination of the evaluation value while changing the hyperparameter until an end condition is satisfied.

2. The information processing apparatus according to claim 1,
wherein the processor is configured to determine a hyperparameter to be selected next based on the evaluation value.

3. The information processing apparatus according to claim 1,
wherein the plurality of pieces of construction data are acquired in a plurality of domains, and
the processor is configured to divide the plurality of pieces of construction data into the plurality of data sets for each of the domains.

4. The information processing apparatus according to claim 1,
wherein the end condition includes at least one of the number of times of selection of the hyperparameter, a processing time for determining the hyperparameter, or an achievement criterion of the evaluation value.

5. An information processing method executed by a computer, the method comprising:
dividing a plurality of pieces of construction data used to construct a learning model into a plurality of data sets having a common probability distribution followed by the construction data;
applying a hyperparameter selected from a plurality of hyperparameters related to the learning model to the learning model to derive an evaluation result for each of the plurality of data sets;
determining a lowest evaluation result from among the evaluation results for each of the plurality of data sets as an evaluation value for the selected hyperparameter; and
determining the hyperparameter by repeating the derivation of the evaluation result and the determination of the evaluation value while changing the hyperparameter until an end condition is satisfied.

6. A non-transitory computer-readable storage medium that stores an information processing program causing a computer to execute:
a procedure of dividing a plurality of pieces of construction data used to construct a learning model into a plurality of data sets having a common probability distribution followed by the construction data;
a procedure of applying a hyperparameter selected from a plurality of hyperparameters related to the learning model to the learning model to derive an evaluation result for each of the plurality of data sets;
a procedure of determining a lowest evaluation result from among the evaluation results for each of the plurality of data sets as an evaluation value for the selected hyperparameter; and
a procedure of determining the hyperparameter by repeating the derivation of the evaluation result and the determination of the evaluation value while changing the hyperparameter until an end condition is satisfied.
